(19) United States
(12) Patent Application Publication
(10) Pub. No.: US 2006/0290465 A1
(43) Pub. Date: Dec. 28, 2006

(54) Remot control system for home appliance and method the same

(76) Inventors: Seog Ho Go, Kyungsangnam-do (KR); Yong Hoan Kwon, Busan-si (KR); Ju Sung Kwak, Busan-si (KR)

Correspondence Address: MCKENNA LONG & ALDRIDGE LLP, 1900 K STREET, NW, WASHINGTON, DC, 20006, US

(21) Appl. No.: 10/573,912

(22) PCT Filed: May 31, 2005
(86) PCT No.: PCT/KR05/01621

§ 371 Date: Mar. 30, 2006

(30) Foreign Application Priority Data
Jun. 7, 2004 (KR) 1020040047737
Jun. 7, 2004 (KR) 1020040041417

(51) Int. Cl. H04Q 9/00; G05B 23/02

(52) U.S. Cl. 340/3.7; 340/310.11; 340/825.72; 398/107

(57) ABSTRACT

A remote control system for home appliance includes: at least one home appliance installed at a place remote from a user's life space; a monitoring device connected to the home appliance wirelessly or via a cable to transmit/receive data to/from the home appliance; and a remote controller connected to the monitoring device wirelessly to control an operation of the home appliance.

### TECHNICAL FIELD

The present invention relates to a remote control system and an operating method thereof, and more particularly, to a remote control system and an operating method thereof, in which an operation state of a home appliance installed remotely, such as a washing machine or drier, can be monitored and its operation can be controlled by using an infrared remote controller.

### BACKGROUND ART

Generally, a washing machine is an apparatus that removes dirt from clothes loaded into a washing tub by using an electricity to rotate the washing tub according to a selected washing cycle. In the washing machine, the washing tub is alternately rotated in the forward direction and in the reverse direction and thus the water jet is generated in the washing tub. The friction or collision between the washing water and the clothes removes the dirt from the clothes. The dirt can be surely removed by the surfactant dissolved in the washing water.

The washing machine includes a washing tub for containing clothes, a motor for rotating the washing tub, an input unit for inputting a washing condition, a display unit for displaying a washing state, and a microcomputer for controlling an overall operation of the washing machine, including a washing cycle.

In addition, a drier for drying the washed clothes includes a drier drum for containing the clothes, a motor for driving the drier drum, an input unit for inputting a drying condition, and a display unit for displaying a drying state, and a microcomputer for controlling an overall drying operation.

Meanwhile, if the washing machine or the drier is located at a place remote from a life space, for example a basement or an outdoor place, it is difficult for the user to immediately check the operation state of the washing machine or the drier.

In addition, even when the operation of the washing machine or the drier is finished, the user may leave the clothes in the washing machine or the drier for a long time. When the washing machine or the drier operates abnormally, the user cannot immediately cope with it.

### DISCLOSURE OF INVENTION

Technical Problem

Accordingly, the present invention is directed to a remote control system for home appliance and an operating method thereof that substantially obviate one or more problems due to limitations and disadvantages of the related art

An object of the present invention is to provide a remote control system for home appliance and an operating method thereof, in which an operation of a washing machine or a drier can be easily controlled at a remote place, and a washing or drying state can be immediately checked to thereby increase the user convenience.

Technical Solution

In an aspect of the present invention, there is provided a remote control system for home appliance, including: at least one home appliance installed at a place remote from a user's life space; a monitoring device connected to the home appliance wirelessly or via a cable to transmit/receive data to/from the home appliance; and a remote controller connected to the monitoring device wirelessly to control an operation of the home appliance.

In another aspect of the present invention, there is provided a remote control system for home appliance, including: a monitoring device for monitoring an operation state of a home appliance installed remotely; a remote controller for wirelessly transmitting/receiving data to/from the monitoring device; and a communication device for exchanging data between the monitoring device and the home appliance.

In a further aspect of the present invention, there is provided a remote control method for home appliance, including: turning on a monitoring device and displaying a state of the home appliance thereon; inputting an operation condition of the home appliance through a remote controller; transmitting the inputted operation condition to the monitoring device; transmitting the operation condition received by the monitoring device to the home appliance, so that the home appliance operates; and displaying an operation state of the home appliance on the monitoring device and transmitting the operation state of the home appliance to the remote controller.

Advantageous Effects

In a remote control system for home appliance and an operating method thereof according to the present invention, an operation state of a washing machine or a drier installed at a place remote from a life space, for example a basement or an outdoor place, can be easily monitored in an indoor place. That is, the operation state of the washing machine or the drier can be checked without the user's moving to the remote place. In addition, the user can immediately check whether the malfunction occurs in the washing machine or the drier.

### Brief Description of the Drawings

FIG. 1 illustrates a remote control system for home appliance according to a first embodiment of the present invention.

FIG. 2 illustrates a remote control system for home appliance according to a second embodiment of the present invention.

FIG. 3 is a block diagram of a monitoring device in the remote control system for home appliance according to an embodiment of the present invention.

FIG. 4 is a block diagram of a remote controller in the remote control system for home appliance according to an embodiment of the present invention.

FIG. 5 is a flowchart illustrating an operation of the remote control system for home appliance according to an embodiment of the present invention.

FIG. 6 illustrates a remote control system for home appliance according to a third embodiment of the present invention.

FIG. 7 illustrates a remote control system for home appliance according to a fourth embodiment of the present invention.

FIG. 8 is a block diagram of a communication device according to an embodiment of the present invention.

### BEST MODE FOR CARRYING OUT THE INVENTION

It will be apparent to those skilled in the art that various modifications and variations can be made in the present invention. Thus, it is intended that the present invention covers the modifications and variations of this invention provided they come within the scope of the appended claims and their equivalents.

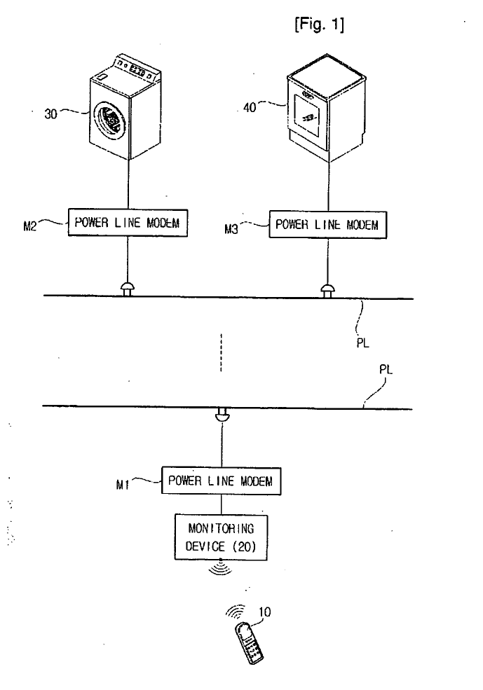

FIG. 1 illustrates a remote control system for home appliance according to a first embodiment of the present invention.

Referring to FIG. 1, the remote control system includes a washing machine 30 located at a basement or an outdoor place and connected via a power line network PL established in an indoor place, a drier 40 located adjacent to the washing machine 30, a monitoring device 20 connected to the washing machine 30 or the drier 40 via the power line network PL to monitor operation states of the washing machine 30 or the drier 40, and a remote controller 10 for remotely controlling the washing machine 30 or the drier 40 through the monitoring device 20. The home appliances appliable to the present invention are not limited to the washing machine 30 and the drier 40, but can include other kinds of home appliances, such as a microwave oven and a dishwasher.

Meanwhile, a power line modem M2 is provided at a side of the washing machine 30 so as to transmit/receive data via the power line network PL. The washing machine performs a washing operation according to a control command received from the power line modem M2 via the power line network PL, and the power line modem M2 transmits a progressing state of the washing cycle, an operation result, or an occurrence or not of malfunction via the power line network PL.

In addition, a power line modem M3 is provided at a side of the drier 40 so as to transmit a drying state of the clothes and an operation result via the power line network PL. The drier 40 dries the clothes according to a control command received from the power line modem M3.

The control commands inputted to the washing machine 30 or the drier 40 are transmitted from the remote controller 10 to the monitoring device 20. The monitoring device 20 enables the user to monitor the operation state of the washing machine 30 or the drier 40 in the indoor life space. Also, a power line modem M1 is provided at the monitoring device 20 so as to enable data transmission/reception to/from the washing machine 30 or the drier 40.

The monitoring device is a kind of a display device that can display the operation states of the various devices connected via the power line network PL. The monitoring device can include an audio or video device. Also, the monitoring device can include a display device, such as a dedicated monitoring device or TV.

The remote controller 10 controls the operation of the washing machine 30 or the drier 40 through the monitoring device 20. The remote controller 10 transmits the control command for the operation of the washing machine 30 or the drier 40 through an infrared communication with the monitoring device 20. The monitoring device 20 transmits the control command to the washing machine 30 and the drier 40 via the power line network PL, so that the washing machine 30 or the drier 40 performs an operation according to the control command.

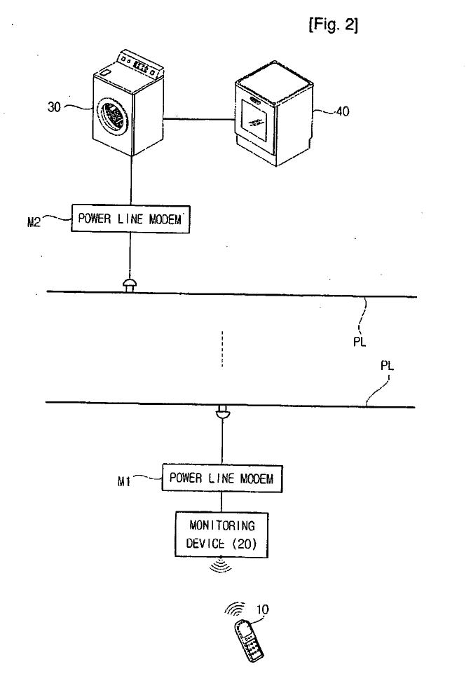

FIG. 2 illustrates a remote control system for home appliance according to a second embodiment of the present invention.

Referring to FIG. 2, in the remote control system, a drier 40 does not include a separate power line modem. That is, the drier 40 is connected to a washing machine 30 and transmits/receives data through a power line modem M2 of the washing machine 30.

Specifically, the remote control system includes the washing machine 30, the drier 40, a monitoring device 20, and a remote controller 10.

More specifically, the drier 40 is connected via a cable to the washing machine 30 for data communication. The cable can be a general communication cable such as RS-232, or a local area network (LAN) cable.

Such a structure does not require a cabling for establishing an additional power line network that connects the washing machine 30 and the drier 40. Thus, an installation cost is reduced.

FIG. 3 is a block diagram of the monitoring device in the remote control system for home appliance according to an embodiment of the present invention.

Referring to FIG. 3, the monitoring device 20 includes an infrared communication module 22 for enabling data transmission/reception with the remote controller 10, a display unit 24 for displaying the operation state of the washing machine 30 or the drier 40, and a data storage unit 23 for storing data received from the washing machine 30 or the drier 40.

The monitoring device 20 further includes a microcomputer 21 for processing data transmitted/received to/from the washing machine 30 or the drier 40, and allowing the control command, which is received from the remote controller 10, to be transmitted to the washing machine 30 or the drier 40 via the power line modem M1. The monitoring device 20 further includes an input unit 25 with a plurality of buttons for controlling the operation of the main body.

The infrared communication module 22 receives the control command of the washing machine 30 or the drier 40 from the remote controller 10 in an infrared communication scheme and transmits it to the microcomputer 21. Also, the infrared communication module 22 transmits data about the operation state from the microcomputer 21 to the remote controller 10.

The data storage unit 23 temporarily stores the data transmitted from the infrared communication module 22 before the data is transmitted through the power line modem M1. Also, the data storage unit 23 stores the operation state and operation data of the washing machine 30 or the drier 40, which are received through the power line modem M1.

The microcomputer 21 includes an input/output control unit 21b and a data processing unit 21a. The input/output control unit 21b drives the monitoring device 20 according to the control command transmitted from the input unit 25, and allows the operation state of the washing machine 30 or the drier 40 to be displayed on the display unit 24. The data processing unit 21 a processes the data received through the infrared communication module 21 or the power line modem M1, and allows the processed data to be displayed on the display unit 24.

The input/output control unit 21b allows the operation state of the washing machine 30 or the drier 40 to be displayed on the display unit 24 visually or audibly. The input/output control unit 21b manipulates the remote controller 10 according to the data received from the remote controller 10 and allows the setting state to be displayed on the display unit 24.

The data processing unit 21a controls the data, which is transmitted/received to/from the different communication media such as the infrared communication module 22 or the power line modem M1, to be correctly transmitted to their destinations. In other words, the control command received from the remote controller 10 is transmitted to the washing machine 30 or the drier 40 through the power line modem M1, and the data about the operation state received from the washing machine 30 or the drier 40 is transmitted through the infrared communication module 22.

The data processing unit 21a temporarily stores the received data in the data storage unit 23, transmits the stored data to the input/output control unit 21b, and displays the data on the display unit 24.

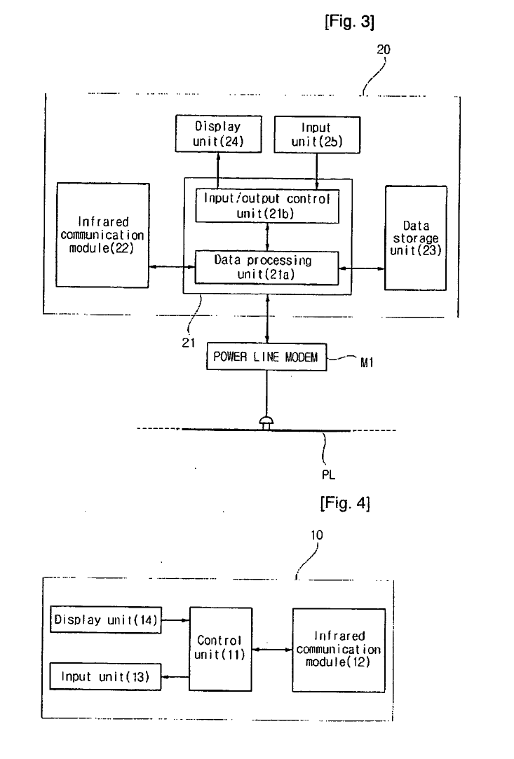

FIG. 4 is a block diagram of the remote controller in the remote control system for home appliance according to an embodiment of the present invention.

Referring to FIG. 4, the remote controller 10 includes an input unit 13 for setting the operation of the washing machine 30 or the drier 40, an infrared communication module 12 for transmitting/receiving data to/from the monitoring device 20, and a control unit 11 for generating a control command for controlling the washing machine 30 or the drier 40 according to the content inputted through the input unit 13.

The remote controller 10 further includes a display unit 14 for displaying the set content and brief information on the operation of the washing machine 30 or the drier 40.

The input unit 13 includes a selection button (not shown) for selecting home appliance such as the washing machine 30 and the drier 40, and a plurality of buttons (not shown) for controlling the operation of the washing machine 30 or the drier 40. Also, the input unit 13 further includes a plurality of buttons (not shown) for controlling the monitoring device 20.

The control unit 11 controls the operation of the washing machine 30 or the drier 40 according to the set content inputted through the input unit 13, and also controls the operation of the monitoring unit 20.

The control unit 11 allows the brief information on the operation state and operation result of the washing machine 30 or the drier 40 to be displayed on the display unit 14. The operation state and operation result of the washing machine 30 or the drier 40 are received from the infrared communication module 12.

Accordingly, the remote control system having the above structure can allow the user to check the state of the washing machine 30 or the drier 40, which is located at a remote place such as a basement or an outdoor place, in the indoor life space and can conveniently control it through the remote controller.

In addition, the remote control system enables the user to check the brief information on the-operation state of the washing machine or the drier through the remote controller without the user's moving up to the monitoring device 20.

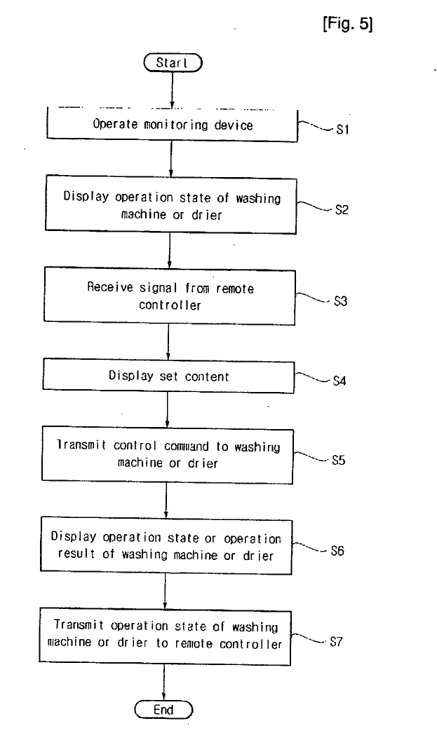

FIG. 5 is a flowchart illustrating an operation of the remote control system for home appliance according to an embodiment of the present invention.

Referring to FIG. 5, in operation S1, the monitoring device 20 is supplied with a power and is operated. In operation S2, the current operation state of the washing machine 30 or the drier 40 remotely located is displayed on the monitoring device 20. In operation S3, whether the washing machine 30 or the drier 40 operates normally or abnormally is checked from the operation state displayed on the monitoring device 20. The control command data transmitted from the remote controller 10 in the infrared communication scheme is inputted to the monitoring device 20. In operation S4, the content set according to the inputted control command data is displayed on the monitoring device 20.

In operation S5, the monitoring device 20 displays the control command data received from the remote controller 10. Also, when the operation setting of the washing machine 30 or the drier 40 is completed, the control command data is transmitted to the washing machine 30 or the drier 40 via the power line network PL. In operation S6, the operation state and operation result of the washing machine 30 or the drier 40 are received via the power line network PL and are displayed visually or audibly so that the user can recognize the received data. In operation S7, the data about the washing machine 30 or the drier 40 are displayed and the brief information related in to the data about the operation state of the washing machine 30 or the drier 40 is transmitted to the remote controller 10 in the infrared communication scheme. The remote controller 10 displays the received data on the display screen, thereby allowing the user to check the operation state of the washing machine 30 or the drier 40.

Mode for the Invention

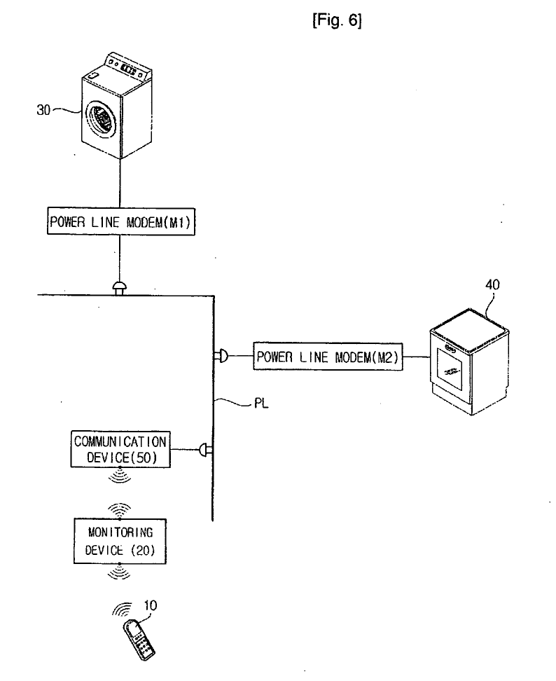

FIG. 6 illustrates a remote control system for home appliance according to a third embodiment of the present invention.

Referring to FIG. 6, the remote control system according to the second embodiment of the present invention has a structure similar to that of the first embodiment of the present invention, and includes a washing machine 30, a drier 40, a monitoring device 20, and a remote controller 10.

Also, the remote control system further includes a communication device 50 for enabling data transmission between the washing machine 30 or the drier 40 and the monitoring device 20. In the first embodiment, the command inputted to the monitoring device 20 is transmitted to the washing machine 30 or the drier 40 in the cable communication scheme. however, in the second embodiment, the command inputted to the monitoring device 20 is transmitted to the washing machine 30 or the drier 40 in the wireless communication scheme.

Specifically, the washing machine 30 and the drier 40 include power line modems M1 and M2 that can provide data transmission/reception via the power line network PL, respectively. The washing machine 30 may be a combined washing machine and drier that has both a washing function and a drying function.

In addition, the remote controller 10 receives an operation command from the user and transmits a corresponding control command to the monitoring device 20 so as to control the operation of the washing machine 30 or the drier 40 located remotely. The remote controller 10 receives the operation state or operation result based on the control command from the monitoring device 20. The remote controller 10 transmits/receives the data to/from the monitoring device 20 in the infrared communication scheme.

The monitoring device 20 monitors the operation state of the washing machine 30 or the drier 40 located in a basement or outdoor place remote from the life space, and immediately displays the data received from the remote controller 10, thereby enabling the user to check the operation setting content set by the remote controller 10.

The monitoring device 20 is a display device that represents the operation state data in a form of video image or audio. The monitoring device 20 may be a dedicated monitoring device or TV. The structure and function of the above-described elements are equal or similar to those of the second embodiment.

Meanwhile, the monitoring device 20 that is characteristic of the present invention receives the control command data from the remote controller 10 through the infrared communication and transmits the received control command to the washing machine 30 or the drier 40 through the communication device 50. The monitoring device 20 transmits the control command to the washing machine 30 or the drier 40 to enable it to operate. Also, the monitoring device 20 transmits the operation state data of the washing machine 30 or the drier 40 to the remote controller 10.

The communication device 50 transmits/receives data to/from the monitoring device 20 in the infrared communication scheme, and transmits/receives the data via the power line network PL to/from the power line modems M1 and M2 connected to the washing machine 30 or the drier 40. That is, due to the communication device 50, the control command and the data about the operation state can be transmitted/received to/from the monitoring device 20 through the infrared communication media and/or the power line communication media.

More specifically, the communication device 50 receives the control command from the monitoring device 20 and transmits it to the washing machine 30 or the drier 40 via the power line network PL. Also, the communication device 50 receives the operation state and operation result of the washing machine 30 or the drier 40 based on the control command via the power line network PL, and transmits them to the monitoring device 20 in the infrared communication scheme.

FIG. 7 illustrates a remote control system according to a fourth embodiment of the present invention.

While the structure and function of the remote control system shown in FIG. 7 is equal to those of the third embodiment, a drier 40 does not include an additional power line modem connected to the power line network PL and transmits/receives data through the washing machine 30. That is, the drier 40 is connected to the washing machine 30 via a cable and thus transmits/receives data through the power line modem connected to the washing machine 30.

Like the second embodiment, the cable may be the LAN cable or the serial communication cable.

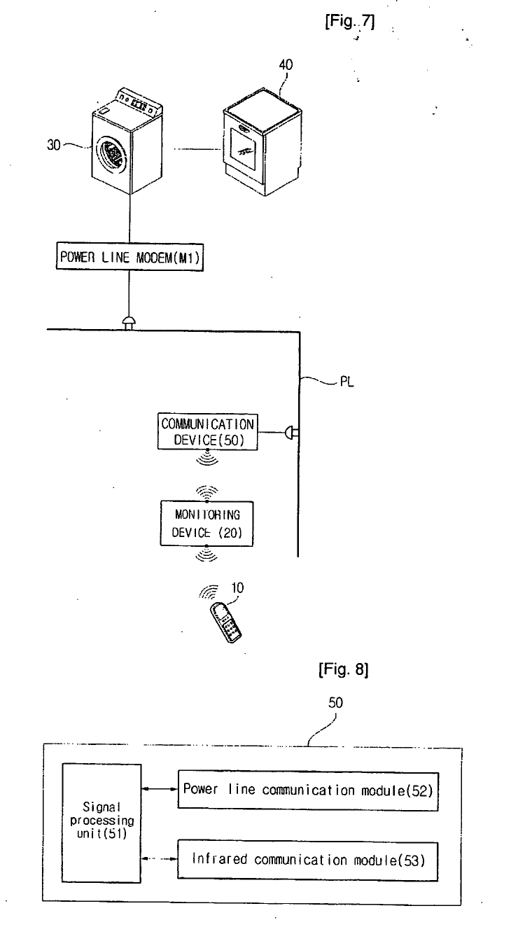

FIG. 8 is a block diagram of the communication device according to an embodiment of the present invention.

Referring to FIG. 8, the communication device 50 includes a signal processing unit 51, a power line communication module 52, and an infrared communication module 53.

Specifically, the infrared communication module 53 receives the control command data from the monitoring device 20 through the infrared communication and transmits the operation state data received from the washing machine 30 or the drier 40 to the monitoring device 20. The power line communication module 52 receives the control command data from the monitoring device 20 and transmits it to the washing machine 30 or the drier 40 via the power line network PL. Also, the power line communication module 52 receives data from the washing machine 30 or the drier 40. The signal processing unit 51 allows the data, which is received from the power line communication module 52 or the infrared communication module 53, to be transmitted to their destinations, and enables the communication between the different communication media.

Industrial Applicability

In the remote control system and the operating method thereof according to the present invention, the user can easily control the operation of the remotely-located home appliances through the remote controller or the monitoring device, and can immediately check the operation states of the home appliances. Accordingly, the remote control system and the operating method thereof according to the present invention has the very high industrial applicability.

1. A remote control system for home appliance, comprising:
at least one home appliance installed at a place remote from a user's life space; a monitoring device connected to the home appliance wirelessly or via a cable to transmit/receive data to/from the home appliance; and
a remote controller connected to the monitoring device wirelessly to control an operation of the home appliance.

2. The remote control system according to claim 1, wherein the home appliance is a washing machine or a drier.

3. The remote control system according to claim 1, wherein the monitoring device comprises:
a display unit for displaying an operation state of the home appliance; an infrared communication module for commnunicating with the remote controller;
a data storage unit for storing data received from the remote controller or the home appliance; and
a microcomputer for controlling an operation of the home appliance according to a command transmitted from the remote controller.

4. The remote control system according to claim 3, wherein the microcomputer comprises:
an input/output control unit for allowing the operation state of the home appliance to be displayed on the display unit; and
a data processing unit for processing the data transmitted from the remote controller or the home appliance.

5. The remote control system according to claim 1, wherein the monitoring device comprises an input unit for enabling a setting of an operation of a main body.

6. The remote control system according to claim 1, wherein the remote controller comprises:
an input unit having a plurality of buttons for inputting a control command; an infrared communication module for transmitting/receiving data to/from the monitoring device; and
a control unit for transmitting the control command inputted from the input unit to the monitoring device.

7. The remote control system according to claim 1, wherein the remote controller comprises a display unit for displaying information on an operation state of the home appliance, which is received from the monitoring device.

8. The remote control system according to claim 1, further comprising a power line modem provided at the monitoring device and/or the home appliance to enable data transmission/reception.

9. The remote control system according to claim 1, wherein the monitoring device and the home appliance are connected to a power line network and transmits/receives data therethrough.

10. The remote control system according to claim 1, wherein the home appliance comprises a first home appliance and a second home appliance, the first home appliance being connected to the monitoring device via a power line network, the second home appliance being connected to the second home appliance via a communication cable.

11. The remote control system according to claim 1, wherein the monitoring device comprises an infrared communication module, the monitoring device being wirelessly connected to a communication device connected to the home appliance via a power line network.

12. The remote control system according to claim 11, wherein the communication device comprises:
an infrared communication module for transmitting/receiving data and control command to/from the monitoring device;
a power line communication module for transmitting/receiving data to/from the home appliance; and
a data processing unit for processing the data transmitted/received to/from the monitoring device and/or the home appliance.

13. A remote control system for home appliance, comprising:
a monitoring device for monitoring an operation state of a home appliance installed remotely;
a remote controller for wirelessly transmitting/receiving data to/from the monitoring device; and
a communication device for exchanging data between the monitoring device and the home appliance.

14. The remote control system according to claim 13, wherein the monitoring device and the communication device exchange data with each other through an infrared communication module.

15. The remote control system according to claim 13, wherein the communication device and the home appliance are connected together via a power line network.

16. The remote control system according to claim 15, wherein at least two home appliances are provided, the at least two home appliances being connected to the power line network and having power line modems for receiving control command from the communication device.

17. The remote control system according to claim 13, wherein two or more home appliances are provided, only one of the home appliances being connected to the communication device and a power line network, the remaining home appliances being connected together via a communication cable.

18. A remote control method for home appliance, comprising:
turning on a monitoring device and displaying a state of the home appliance thereon;
inputting an operation condition of the home appliance through a remote controller; transmitting the inputted operation condition to the monitoring device;
transmitting the operation condition received by the monitoring device to the home appliance, so that the home appliance operates; and
displaying an operation state of the home appliance on the monitoring device and transmitting the operation state of the home appliance to the remote controller.

19. The remote control method according to claim 18, wherein the operation of transmitting the operation condition to the home appliance comprises:
inputting command data transmitted from the monitoring device to a communication device connected to the home appliance via a cable; and
transmitting the command data received by the communication device to the home appliance.

20. The remote control method according to claim 19, wherein the command data transmitted from the monitoring device is inputted to the communication device through an infrared module.

21. The remote control method according to claim 18, wherein the command data is transmitted from the monitoring device to the home appliance via a power line network or an infrared communication.
